(19) United States
(12) Patent Application Publication
(10) Pub. No.: US 2009/0321667 A1
(43) Pub. Date: Dec. 31, 2009

(54) SERVO VALVE MODULES AND TORQUE MOTOR ASSEMBLIES

(75) Inventor: Mike McCollum, Tempe, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/146,230

(22) Filed: Jun. 25, 2008

(51) Int. Cl. F16K 31/00

(52) U.S. Cl. 251/61

(57) ABSTRACT

Servo valve modules and torque motor assemblies are provided. In an embodiment, a servo valve module includes a housing assembly, a diaphragm, a valve assembly, and a spiral washer. The housing assembly includes two chambers, a valve port, an intake port, and an outlet flow channel. The diaphragm extends across one chamber to divide the chamber into a pressure reception section and a pressure transmission section. The valve assembly includes a valve seat adjacent to the valve port in the other chamber, a valve element to seat and unseat against the valve seat, and a valve plate in the pressure transmission section including a valve stem extend axially and disposed in the valve port to contact the valve element. The spiral washer is coupled to the valve element and extends across the chamber to provide a preload against the valve element to bias the element toward the closed position.

### TECHNICAL FIELD

The inventive subject matter generally relates to aircraft control systems, and more particularly relates to servo valves and torque motors that may be used in the systems.

### BACKGROUND

Gas turbine engines may be used to power aircraft and may include a fan section, a compressor section, a combustor section, a turbine section, and an exhaust section. The fan section is positioned at the front, or “inlet” section of the engine, and includes a fan that induces air from the surrounding environment into the engine. The fan section accelerates a fraction of the air toward the compressor section. The remaining fraction of air is accelerated into and through a bypass plenum, and out the exhaust section. The compressor section raises the pressure of the air it receives from the fan section to a relatively high level. The compressed air then enters the combustor section, where a ring of fuel nozzles injects a steady stream of fuel into the air. The injected fuel is ignited by a burner, which significantly increases the energy of the compressed air. The high-energy compressed air then flows into and through the turbine section, causing rotationally mounted turbine blades to rotate and generate energy. The air exiting the turbine section is exhausted from the engine via the exhaust section, and the energy remaining in this exhaust air aids the thrust generated by the air flowing through the bypass plenum.

Many gas turbine engines, such as the above-described turbofan gas turbine engine, selectively bleed air from the compressor section for the operation of aircraft systems that may be at least partially pneumatically operated. In one example, the bleed air may be diverted to a pneumatic control system, which controls a flow of air along a main flowpath leading to a component, such as a starter. To do so, the pneumatic control system may control a valve that is disposed in the main flowpath. In one configuration, the bleed air enters a pressure regulator, which regulates and maintains the air pressure at a constant value. The bleed air then flows to a torque motor. The torque motor receives electrical signals that correspond with a desired valve command from a remote controller and converts the signals into pressure signals by allowing a particular magnitude of the bleed air through. The particular magnitude of bleed air then flows to the actuator, which may open the valve in the main flowpath to thereby allow air to be fed to the component.

Although conventional torque motors operate adequately in most circumstances, they may be improved. In particular, conventional torque motors may have limited airflow capacity and thus, may not be suitable for use with larger actuators. Additionally, torque motors may not operate as efficiently in the presence of small leaks in the system. For example, in system configurations in which the torque motor may have a relatively small output airflow orifice (e.g., less than 0.5 mm), leaks anywhere downstream of the torque motor may degrade operation of the torque motor by reducing the level of pressure delivered to the downstream system. To provide an increased airflow capacity of air so that the torque motor may provide sufficient air to a larger actuator, a separate, second stage servo may be disposed between the torque motor and the actuator. However, conventional second stage servos typically are large, separate devices from the torque motors that increase equipment size and weight.

Accordingly, it is desirable to have an improved pneumatic control system that efficiently increases an airflow capacity. In addition, it is desirable to have a second stage servo that may be suitable for use with relatively small torque motors (e.g., torque motors having an output airflow orifice diameter that is less than about 0.5 mm). Moreover, it is desirable for the improved second stage servo to have an improved ability to increase an airflow capacity, even in the presence of a downstream leak. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Servo valve modules and torque motor assemblies are provided.

In an embodiment, by way of example only, a servo valve module includes a housing assembly, a diaphragm, a valve assembly, and a spiral washer. The housing assembly includes a connector plate and a cover plate coupled to the connector plate to define a first chamber, a second chamber, a valve port, an intake port, and an outlet flow channel, wherein the first chamber is in flow communication with the intake port, the valve port provides communication between the first chamber and the second chamber, and the second chamber is disposed between the first chamber, the output port, and the inlet channel. The diaphragm extends across the second chamber to divide the second chamber into a pressure reception section and a pressure transmission section, wherein the pressure reception section is isolated from the pressure transmission section, and the pressure transmission section is in flow communication with the first chamber and the output port. The valve assembly is disposed within the housing assembly and includes a valve seat, a valve element, and a valve plate. The valve seat is adjacent to the valve port in the first chamber. The valve element is disposed in the first chamber and adapted to seat and unseat against the valve seat. The valve plate is disposed in the pressure transmission section of the second chamber and includes a valve stem extend axially therefrom, the valve stem disposed in the valve port and adapted to contact the valve element. The spiral washer is coupled to the valve element and extending across at least a portion of the chamber and is adapted to provide a preload against the valve element to bias the element toward the closed position.

In another embodiment, by way of example only, the torque motor assembly includes a torque motor module and a servo valve module. The torque motor module includes a torque motor plate including a main flowpath and an output port in flow communication therewith, and a first valve element disposed between the main flowpath and the outlet port. The servo valve module is detachably coupled to the torque motor module and includes a housing assembly, a diaphragm, a valve assembly, and a spiral washer. The housing assembly includes a connector plate and a cover plate. The connector plate is coupled to the torque motor plate and defines a first chamber, a second chamber, a valve port, an intake port, an outlet flow channel, and an inlet channel with the cover plate, wherein the first chamber is in flow communication with the intake port, the valve port providing communication between the first chamber and the second chamber, the second chamber is disposed between the first chamber, the output port, and the inlet channel, and the inlet channel is in communication with the output port of the torque motor plate. The diaphragm extends across the second chamber to divide the second chamber into a pressure reception section and a pressure transmission section, wherein the pressure reception section is in flow communication with the inlet channel and isolated from the pressure transmission section, and the pressure transmission section is in flow communication with the first chamber and the outlet flow channel. The valve assembly is disposed within the housing assembly and includes a valve seat, a second valve element, and a valve plate. The valve seat is adjacent to the valve port in the first chamber. The second valve element is disposed in the first chamber and is adapted to seat and unseat against the valve seat. The valve plate is disposed in the pressure transmission section of the second chamber and includes a valve stem extend axially therefrom, and the valve stem is disposed in the valve port and is adapted to contact the second valve element. The spiral washer is coupled to the second valve element and extends across at least a portion of the chamber and adapted to provide a preload against the second valve element to bias the element toward the closed position.

### BRIEF DESCRIPTION OF THE DRAWINGS

The inventive subject matter will hereinafter be described in conjunction with the following drawing figures, wherein like numerals denote like elements, and

FIG. 1 is a simplified schematic of a pneumatic control valve system, according to an embodiment;

FIG. 2 is a cross-sectional view of a torque motor assembly, according to an embodiment; and

FIG. 3 is a top view of a spring that may be implemented into the torque motor of FIG. 2, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

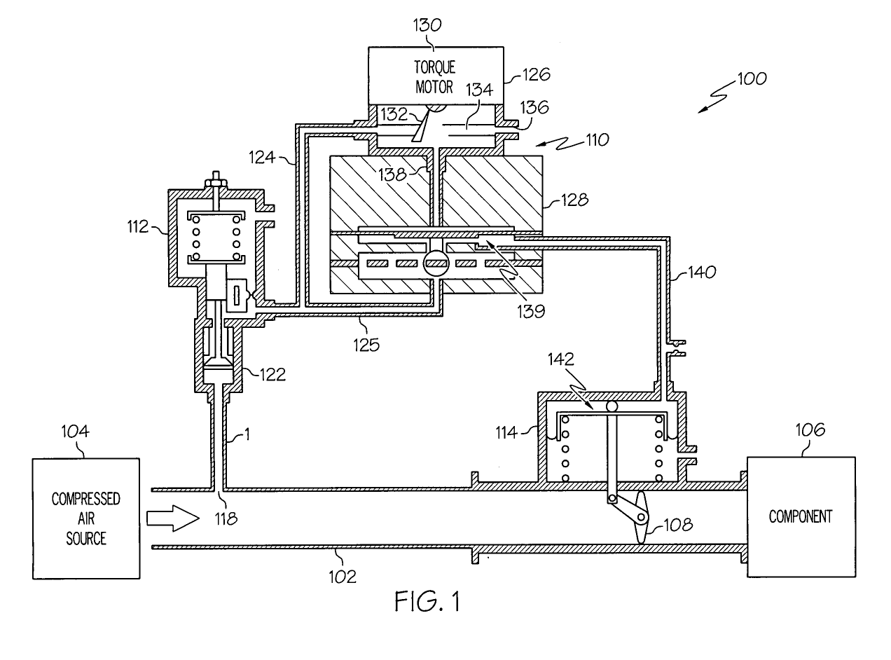

FIG. 1 is a simplified schematic of a pneumatic control valve system 100, according to an embodiment. The system 100 is configured to control airflow through a main duct 102 that connects a compressed air source 104 and a component 106. In an embodiment, the compressed air source may be an auxiliary power unit, a compressor stage of a gas turbine engine or a gas turbine ground power cart, or another device capable of producing compressed air. The component 106 may be an air turbine starter, an environment control system, or any other pneumatically-operated engine or airframe-mounted component of an aircraft system.

In an embodiment, the system 100 may include a valve 108 to control the airflow through the main duct 102. The valve 108 may be disposed in the main duct 102 and may be capable of opening and closing, in response to commands from one or more control components. In one example, the valve 108 may be a butterfly valve, as shown in FIG. 1, a poppet valve, or another suitable type of valve. System 100 may include electro-pneumatically-controlled components, such as a torque motor assembly 110, and/or pneumatically-controlled components, such as a reference pressure regulator 112, and/or an actuator 114 to control the valve 108. In other embodiments, other pneumatically-, electrically-, and/or hydraulically-controlled components may be included, and the valve 108 may be controlled by those components as well.

To operate the system 100, a portion of the airflow from the main duct 102 may be diverted through an opening 118 that leads to a reference pressure line 120. The opening 118 may be located at any axial location along the main duct 102 between the compressed air source 104 and the valve 108. The reference pressure line 120, which may be a duct, pipe, or other component for flowing air, directs the airflow from the main duct 102 to the reference pressure regulator 112. The reference pressure regulator 112 may be adapted to receive air at an input pressure and to output the air at a desired, output pressure. In this way, the air may be fed to a downstream component at a constant pressure. In an embodiment, the reference pressure regulator 112 may do so via a valve 122 that is configured to move between open and closed positions based on the input pressure of the airflow. As used herein, an “open position” may be defined as a valve position allowing flow through of at least 5% of a flow area. A “closed position” may be defined as a valve position blocking substantially all (e.g., more than 99%) flow across a flow area. For example, the reference pressure regulator 112 may be set to a threshold value, so that if the input pressure is above the threshold value, the valve 122 closes (e.g., moves toward a closed position) to lower the pressure of air flowing through the regulator 112 and if the input pressure is below the threshold value, the valve 122 opens (e.g., moves to an open position) to allow the air to flow through the regulator 112. The threshold value may be in a range of from about 10 psi and about 400 psi, in an embodiment. In other embodiments, the threshold value may be larger or smaller than the aforementioned threshold value range. The valve 122 may be any type of valve capable of responding to air pressures in a desired range of threshold values.

When the valve 122 opens, a first portion of the airflow may flow to a first line 124, and a second portion of the airflow may flow a second line 125. The first and second lines 124, 125 may be ducts, pipes, or other components capable of flowing air therethrough. In an embodiment, the first line 124 provides flow communication to the torque motor assembly 110. The torque motor assembly 110 is configured to respond to a command from a controller (not shown) and to use the airflow from the first line 124 to communicate the controller command to the actuator 114. In an example, the torque motor assembly 110 may include a torque motor module 126 and a servo valve module 128. According to an embodiment, the torque motor module 126 may be configured to receive the commands from the controller as an electrical current, and to convert the electrical current into the pressure signal. In this regard, the torque motor module 126 may include a torque motor 130, a valve element 132, and a main flowpath 134. The torque motor 130 may be electrically coupled to the controller and is adapted to move the valve element 132 between first and second positions located in the main flowpath 134, in response to the electrical current provided by the controller. The valve element 132 may be a flapper, as shown in FIG. 1, or a ball, a slide, or any other type of valve element.

In an embodiment, movement of the valve element 132 to a first position may cause at least a portion of air to vent out a vent nozzle 136. In this way, when the controller provides a command to maintain the valve 108 in a biased position (e.g., either a biased closed or a biased open position), then no pressure signal is transmitted to the system components and the valve 108 remains in a steady state. The vent nozzle 136 may bleed the air through a fixed orifice having an effective diameter within a range of between about 0.076 cm to about 0.152 cm, in an embodiment. In other embodiments, the vent nozzle 136 may include a variable diameter orifice that may be adjusted to have a diameter within the aforementioned range.

In another embodiment, the controller may provide a command to move the valve 108 out of the biased position. Thus, the valve element 132 may be moved to the second position, which may cause the air to flow through an output port 138 into the servo valve module 128. When the air reaches an appropriate chamber in the servo valve module 128, it may be used to transmit the pressure signal to the second portion of airflow that is directed to the servo valve module 128 via the second line 125.

The servo valve module 128 is adapted to provide an airflow to the actuator 114 at a capacity that is larger than an airflow capacity of the torque motor module 126. In an embodiment, the servo valve module 128 may include a valve assembly 139 therein that moves between an open and a closed position, in response to the pressure signal received from the torque motor module 128. While in the open position, the air having the desired airflow capacity is delivered to the actuator 114 via a third line 140. The third line 140 may be a duct, a pipe, or other component capable of directing airflow. The actuator 114 may include a piston 142 that responds to the pressure signal from the air received from the third line 140 to move and to thereby supply torque to the valve 108 in a desired direction and at a desired rate. While the valve assembly is in the closed position, the air may be maintained within the servo valve module 130, until the pressure signal is received.

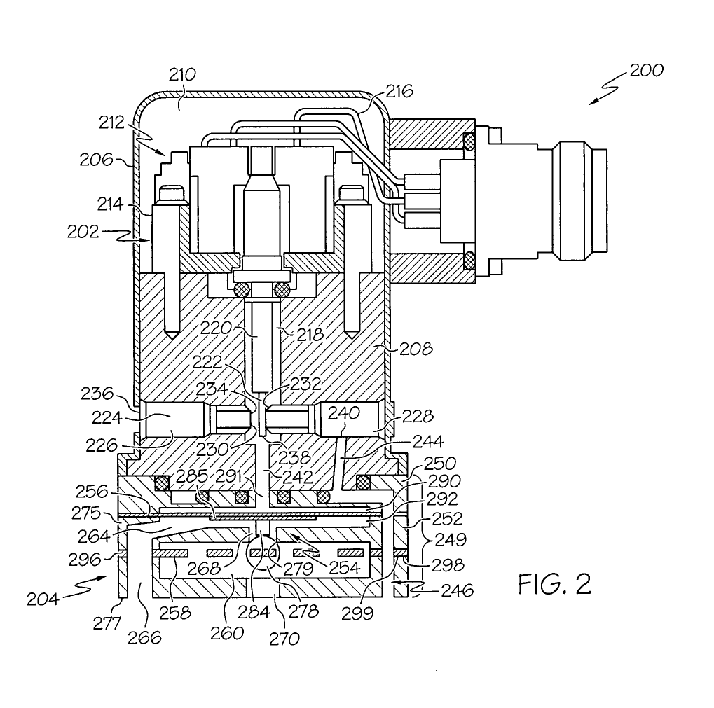

FIG. 2 is a cross-sectional view of a torque motor assembly 200 (e.g., torque motor assembly 110, FIG. 1), according to an embodiment. The torque motor assembly 200 may be implemented into the control system 100 shown in FIG. 1, in an embodiment, and will be described in conjunction therewith. However, it will be appreciated that the torque motor assembly 200 may be incorporated into any other pneumatic system, in which airflow may need to be controlled. In any case, in an embodiment, the torque motor assembly 200 includes a torque motor module 202 and a servo valve module 204. The two modules 202, 204 may be configured as separate modules that may be manufactured independently from one another. In such case, as shown, the torque motor module 202 and the servo valve module 204 may be press-fit, bolted, screwed, or otherwise coupled together. To prevent unwanted leakage of air flowing therebetween, one or more O-rings, or other type of suitable seal, may be disposed between the two modules 202, 204, according to an embodiment. In other embodiments, the two modules 202, 204 may be integrally formed as a single structure.

The torque motor module 202 may include an outer housing 206 and a torque motor plate 208 inserted at least partially therein to form a cavity 210. A torque motor 212 may be disposed within the cavity 210 and may be mounted to the torque motor plate 208 via a mount plate 214. In an example, the mount plate 214 and the torque motor plate 208 are coupled together using one or more screws or bolts. In other embodiments, the two plates 214, 208 alternatively may be adhesively, or otherwise attached together. In still other embodiments, the two plates 214, 208 may be two sections of a single plate. The torque motor 212 may be an electromagnetically activated galvanometer movement and may be electrically coupled to a controller (not shown). The controller may transmit electrical signals to the torque motor 212 via wire connections 216.

The torque motor plate 208 includes various channels and flowpaths that are configured to house one or more valve components for the control of the air flowing through the torque motor assembly 200. The channels and flowpaths may also be configured to direct airflow to desired locations in the system 100. In an embodiment, the torque motor plate 208 includes a channel 218 that is formed substantially through a center of the torque motor plate 208, and the channel 218 may be adapted to accommodate a stem 220 therein. The stem 220 may include a first valve element 222 extending therefrom that may be coupled to and/or may extend from the torque motor 212. According to an embodiment, the stem 220 may be configured to move radially relative to the channel 218 so that the first valve element 222 may move between a first position and a second position. In this regard, the channel 218 may have a diameter that is larger than an outer diameter of the stem 220 and that allows the stem 220 to move across a desired distance.

The channel 218 may communicate with and the first valve element 222 may extend into a main flowpath 224. In an embodiment, the main flowpath 224 extends through at least a portion of the torque motor plate 208 and may be intersected by the channel 218. According to one embodiment, the main flowpath 224 may have a diameter that is larger than that of the channel 218. For example, the diameter of the main flowpath 224 may be in a range from about 0.254 cm to about 0.318 cm. Alternatively, the diameter may be smaller or larger than the aforementioned range. In yet other embodiments, the main flowpath 224 may have a diameter that is smaller than that of the channel 218. In accordance with another embodiment, the diameter of the main flowpath 224 may be substantially uniform along its length, or in other embodiments, the diameter may vary. Moreover, although the main flowpath 224 is shown as extending substantially perpendicular to the channel 218, the main flowpath 224 may be formed at a different non-parallel angle relative to the channel 218, in other embodiments.

In some embodiments, first and second threaded passages 226, 228 may be included to define a portion of the main flowpath 224. For example, each threaded passage 226, 228 may include two opposing seating surfaces 230, 232 to provide the first and the second positions against which the first valve element 222 may seat. Additionally, each threaded passage 226, 228 may be configured to screw into and out of the main flowpath 224 to provide a means for calibrating a location of the seating surfaces 230, 232. In an embodiment, the first threaded passage 226 may be disposed in a first section of the main flowpath 224 to provide the first seating surface 230 and a first opening 234 on one end and a second opening 236 on an opposite end. The first threaded passage 226 may have an inner diameter that falls within the range of from about 0.076 cm to about 0.229 cm. Each opening 234, 236 may have a particular diameter that may be selected to allow a desired magnitude of air to flow therethrough. In an embodiment, the first opening 234 adjacent to the first seating surface 230 may be sized such that an entirety of the first opening 234 is covered by the first valve element 222, when the first valve element 222 is seated thereagainst. The particular size and shape of the first opening 234 may depend on a particular configuration of the first valve element 222. The first valve element 222 may be a flapper-type of structure, in an embodiment such as shown in FIG. 2, or may be any other type of valve element in other embodiments. In an example, the first opening 234 may have a diameter in a range of between about 0.076 cm to about 0.229 cm. In other embodiments, the diameter may be larger or smaller than the aforementioned range. In another embodiment, the second opening 236 on the first nozzle 226 may vent to ambient and thus, may act as a vent nozzle (such as vent nozzle 134 in FIG. 1). In such case, the second opening 236 may bleed the air through a fixed orifice having a diameter within a range of between about 0.254 cm to about 0.381 cm, in an embodiment. In other embodiments, the second opening 236 may include a variable diameter orifice having a diameter within the aforementioned range. In still other embodiments, the two openings 234, 236 may be substantially similar in size (e.g., ±0.5 mm), or alternatively, one opening may be larger than the other.

The second threaded passage 228 may be disposed in a second section of the main flowpath 224 and may be adapted to include a second seating surface 232 and a third opening 238 on one end for discharging air. A fourth opening 240, which may communicate with the pressure regulator 112 (FIG. 1) may be formed at a location along the length of the second threaded passage 228, in an embodiment. Each opening 238, 240 may have a particular diameter that may be selected to allow a desired magnitude of air to flow therethrough. In an embodiment, the third opening 238 may have a diameter in a range of between about 0.076 cm to about 0.229 cm. According to another embodiment, the third opening 238 may be sized such that an entirety of the third opening 238 is covered by the first valve element 222 when seated thereagainst. The particular size and shape of the third opening 238 may depend on a particular configuration of the first valve element 222. The fourth opening 240 may be sized for minimum loss of pressure to the third opening 238. For example, the fourth opening 240 may have a diameter that is in a range of about 0.254 cm to about 0.381 cm. In other embodiments, the diameter may be larger or smaller than the aforementioned range. In still other embodiments, the two openings 238, 240 may be substantially similar in size (e.g., ±0.5 mm), or alternatively, one opening may be larger than the other.

The torque motor plate 208 may also include an outlet port 242 that communicates with the main flowpath 224. In an embodiment, the outlet port 242 intersects the main flowpath 224 at a location at which the first valve element 220 is disposed. In other embodiments, the outlet port 242 may be disposed in other suitable locations along the main flowpath 224. Although the outlet port 242 is depicted in FIG. 2 as being positioned substantially perpendicular to the main flowpath 224 and axially aligned with the channel 218, the outlet port 242 may be disposed at any other non-parallel angle relative to the main flowpath 224 and/or relative to the channel 218, in other embodiments.

According to another embodiment, the torque motor plate 208 also may include an inlet port 244 formed therein. The inlet port 244 provides communication between the pressure regulator 112 (FIG. 1) and the main flowpath 224. In one example, the inlet port 244 extends from an end of the torque motor plate 208 to the fourth opening 240. In such case, the inlet port 244 may communicate with an inlet channel 246 formed through the servo valve module 204, in an embodiment, or with a separate airflow connection line that communicates with the pressure regulator 112. In other embodiments, the inlet port 244 may not be formed in the torque motor plate 208, and alternatively, may be included as part of a gas connection line, duct, or other type of component suitable for flowing air therethrough. In any case, the inlet port 244 may have a diameter in a range that minimizes pressure drop between the inlet port 244 and the second seating surface, 232 in order to optimize a range of pressure in the outlet port 242.

The servo valve module 204 receives an intake airflow from the pressure regulator 112, where the intake airflow has a flow capacity that is larger than the flow capacity of the torque motor module inlet port 244. Although the servo valve module 204 receiving air from the pressure regulator 112 is described, the servo valve module may also receive air from a passage upstream of the pressure regulator that bypasses the regulator 112, in another embodiment. The servo valve module 204 also receives a pressure signal from the torque motor module 202 to cause the actuator 114 (FIG. 1) to open or close, according to an embodiment. To do so, the servo valve module 204 may include a housing assembly 249, a valve assembly 254, a diaphragm 256, and a spiral washer 258, in an embodiment. As illustrated in FIG. 2, the housing assembly 249 may be coupled to the torque motor plate 208 and may include a connector plate 250 and a cover plate 252, in an embodiment. The connector plate 250 may attach to the torque motor plate 208 and may define a plurality of flowpaths and chambers with the cover plate 252. Although two plates 250, 252 are described, more than two plates 250, 252 may alternatively be included. For example, the cover plate 252 may include more than one section (e.g., two sections, three sections, etc.) that may couple or fit together when the servo valve module 204 is assembled.

In an embodiment, the connector plate 250 and the cover plate 252 may be coupled together and may at least partially define an intake port 270, a first or “intake” chamber 260, a valve port 268, a second chamber 264, an outlet flow channel 266, and an inlet channel 291. According to an embodiment, the intake port 270 may be in flow communication with the second line 138 (FIG. 1) and may include a diameter that is in a range of from about 0.191 cm to about 0.318 cm. Alternatively, the diameter of the intake port 270 may be larger or smaller.

The first chamber 260 is in flow communication with the intake port 270 and may receive the intake airflow therefrom. The valve port 268 provides communication between the first and second chambers 260, 264, and the second chamber 264 communicates with the outlet flow channel 266. In an embodiment, the first chamber 260 may have a larger volume than the second chamber 264, and may be in a range of about 1.64 cc to about 5.0 cc. In other embodiments, the volume may be larger or smaller. The first and second chambers 260, 264 each may have cylindrical shapes. Alternatively, the chambers 260, 264 may have other three-dimensional shapes, such as cylindrical, cubical, or spherical. In some embodiments, both chambers 260, 264 have substantially similar shapes. Alternatively, in other embodiments, the chambers 260, 264 may have different shapes.

The valve port 268 is adapted to define a desired flow capacity of the airflow flowing therethrough. Thus, in an embodiment, if the desired flow capacity is in a range from about 0.075 to about 0.150, the diameter of the valve port 268 may be in a range of from about 0.100 to about 0.175. In other embodiments, the flow capacity and the valve port 268 diameter may be greater or smaller than the aforementioned ranges. In an embodiment, the desired flow capacity is a flow capacity that is larger than a flow capacity of the torque motor module 202. Accordingly, a radial cross-sectional area of the valve port 268 may have a dimension, such as a diameter, that is greater than that of the inlet port 244 of the torque motor module 202. In one example, the flow capacity of the valve port 268 may be about five times greater than that of the torque motor module 202.

The flow capacity of the valve port 268 may be enlarged or made smaller, in some embodiments of the system 100. For example, as mentioned above, the connector plate 250 and the cover plate 252 are detachable from each other. Thus, in some embodiments, the sizing of the valve port 268 may be changed, by incorporating a connector plate 250 and/or cover plate 252 having a selected valve port 268 dimension.

To transmit the pressure signal from the torque motor module 202 to the servo module 204, the valve assembly 254, the spiral washer 258, and the diaphragm 256 are incorporated between the first and the second chambers 260, 264. In an embodiment, the valve assembly 254 includes a second valve element 278 and a valve plate 285. The second valve element 278 is disposed within the first chamber 260 and is adapted to transition from a closed position to an open position by seating against and unseating from a valve seat 279 located on a surface of the first chamber adjacent to the valve port 268, in response to a force exerted against the valve plate 285 disposed within the second chamber 264. In an embodiment, the second valve element 278 may be a ball, a plate, a poppet, or other type of device suitable for seating and unseating against a seating surface. In this regard, the second valve element 278 may have a diameter that is larger than a diameter of the valve port 268. For example, the second valve element 278 may have a diameter that is between about 0.444 cm and about 1.270 cm larger than the diameter of the valve port 268.

The second valve element 278 may be biased toward the valve seat 279 (e.g., towards the closed position) by the spiral washer 258, which is mounted to the cover plate 252. In an embodiment, the spiral washer 258 extends across the first chamber 260 and is coupled to the second valve element 278. In an embodiment, the spiral washer 258 is brazed to the second valve element 278. In other embodiments, the spiral washer 258 is adhered, or otherwise bonded to the second valve element 278.

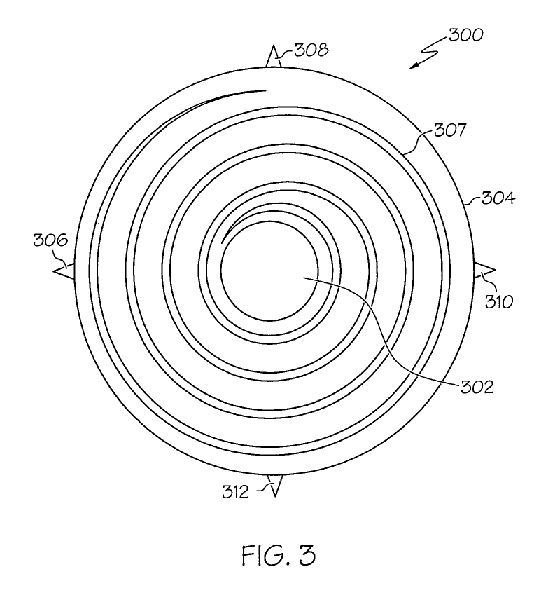

With addition reference to FIG. 3, a top view of a spiral washer 300 is provided, in accordance with an embodiment. The spiral washer 300 may have a flat disk shape and may include a center opening 302, an outer periphery 304, and a spiral cutout 307 formed therebetween. In an embodiment, the washer 300 has a thickness in a range of from about 0.064 cm to about 0.127 cm and an outer diameter in a range of from about 2.5 cm to about 5.0 cm. In some embodiments, however, the particular dimensions of the washer 300 may be larger or smaller, and may be selected based on the dimensions of the second valve element 278, and the first chamber 260, or by the dimensions of the torque motor, 200. The spiral washer 300 may also be selected based on a particular, desired spring constant. For example, the desired spring constant may be one that is suitable for providing a first force, or “preload”, on the second valve element 278 to ensure that the second valve element 278 is biased to the closed position, until a second, opposing force exerted on the valve plate 285 is greater than the spring constant. In an embodiment, the axial spring constant of the spiral washer 300 may be in a range of about 0.2 kg/cm to about 2 kg/cm. In other embodiments, the spring constant may be larger or smaller.

In another embodiment, the spiral washer 300 may be designed to center the second valve element 278 in the valve seat 279 and to guide the second valve element 278 into the valve seat 279, if the valve element 278 closes. In an embodiment, the radial spring constant of the spiral washer 300 may be in a range of about 20 kg/cm to about 40 kg/cm. In other embodiments, the spring constant may be larger or smaller. In this way, the second valve element 278 may be centered in the valve seat 279 without incorporating a long physical guide feature that could increase packaging of the servo module 204.

The center opening 302 may have a diameter that is smaller than a largest diameter of the second valve element 278 (FIG. 2), so that the second valve element 278 may be positioned therein when the spiral washer 300 is mounted to the cover plate 252. According to an embodiment, the diameter of the center opening 302 may be in a range of about 0.075 to about 0.100. In other embodiments, the diameter may be larger or smaller. To mount the spiral washer 300 onto the cover plate 252, the outer periphery 304 may include one or more pilots 306, 308, 310, 312, extending radially outwardly therefrom. In an embodiment, the pilots (e.g., pilots 296, 298 in FIG. 2) may be configured to correspond with a groove (e.g., groove 299 in FIG. 2) formed in the cover plate 252, or may be clamped between sections (e.g., sections 275 and 277 in FIG. 2) of the cover plate, in other embodiments.

Returning to FIG. 3, the spiral cutout 306 may be configured to allow the washer 300 to transform from the flat disk shape into a conical shape, when the force exerted against the washer 300 exceeds its spring constant. In an embodiment, the spiral cutout 306 may have a topology of an Archimedean spiral. An Archimedean spiral may be defined by the following equation:

R=kA

wherein, R represent a radial measure in a circular coordinate system,

k represents a constant that controls spacing between adjacent arcs of the spiral, and

A represents an angular measure in the circular coordinate system.

In one embodiment, R, k, and A may be optimized to provide the washer 300 with the spring constant. According to another embodiment, the spiral cutout 306 may be another shape that produces a high spring rate (e.g., a spring rate greater than about 20 kg/cm) in the radial direction of the washer, but a low spring rate (e.g., a spring rate less than about 2 kg/cm) in the axial direction. In any case, by including the spiral cutout 306 in the spiral washer 300, the washer 300 may be used to impart the desired preload against the second valve element 278.

With reference again to FIG. 2, when the force generated by the pressure signal from the torque motor module 202 exceeds the spring constant of the spiral washer 258, the second valve element 278 may unseat and move to the open position. The pressure signal may be provided to the second valve element 278 via the diaphragm 258 and the valve plate 285. In an embodiment, the diaphragm 254 is disposed within the second chamber 264 to divide the chamber 264 into a pressure reception section 290 and a pressure transmission section 292. As shown in FIG. 2, the pressure reception section 290 communicates with the outlet port 242 of the torque motor module 202 via a torque motor air inlet channel 291 and is isolated from the first chamber 250 of the servo valve module 204, while the pressure reception section 292 communicates with the first chamber 250 and the outlet flow channel 266. In one embodiment, the diaphragm 254 may be clamped between the cover plate 252 and the connector plate 250. In such case, the diaphragm 254 may have a diameter that is greater than a width of the second chamber 264. For example, the diameter of the diaphragm 254 may be in a range of from about 2.5 cm to about 5.0 cm. In other embodiments, the diameter may be larger or smaller. In any case, the diaphragm 254 may be stretched across the second chamber 264 such that the diaphragm 254 is substantially flat. In an embodiment, the diaphragm 254 may be made of a sheet of material that is capable of flexing, in response to a particular pressure exerted from the air in the pressure reception section 290 of the second chamber 264. In an embodiment, the particular pressure may be in a range of from about 0 psi to about 15 psi. In other embodiments, the particular pressure may be larger or smaller, and may depend on a particular magnitude of the pressure signal that will be transmitted from the torque motor module 202. For example, the diaphragm 254 may include a sheet of non-reinforced rubber material. However, other materials, such as reinforced rubber or circumferentially corrugated sheet metal alternatively may be used.

When the diaphragm flexes in response to the pressure signal, the flexing exerts a force against the valve plate 285, which transmits the force to the second valve element 278 via a valve stem 284. In an embodiment, the valve plate 285 may be disk shaped, or alternatively, may have any other shape suitable for receiving a pressure thereagainst, such as rectangular, square, ovular, or any other shape. In an embodiment in which the valve plate 285 is disk shaped, the valve plate 285 may have a diameter in a range from about 1.27 cm to about 3.81 cm. In other embodiments, the valve plate 285 may have a diameter that is larger or smaller than the aforementioned range, such that the diameter is larger than that of the valve port 268. The valve stem 284 extends axially from the valve plate 285 to contact a surface of the second valve element 278. In an embodiment, the valve stem 284 is integrally formed as part of the valve plate 285. In another embodiment, the valve stem 284 is attached to, brazed, adhered, or otherwise coupled to the valve plate 285. Though the valve stem 284 is shown as having a blunt end, the valve stem 284 may alternatively have a rounded end, a pointed end, a beveled end, or an end having any other shape.

After the second valve element 278 unseats, air flows through the valve port 268 to the second chamber 264 as an output airflow to the actuator 114. In an embodiment, the outlet flow channel 266 maybe adapted to include the second, diameter along its length, and may have a diameter in a range of between about 0.381 cm to about 0.635 cm. In other embodiments, the diameter may be larger or smaller than the aforementioned range while maintaining the airflow at the desired pressure.

By coupling a torque motor module to a servo valve module (e.g., servo module 128 in FIG. 1 or servo module 202 in FIG. 2), a larger airflow capacity may be provided and sensitivity to leaks in a pneumatic control system may be decreased as compared to convention systems. Moreover, by including the servo valve module as a detachable module, any one of numerous devices in which increase in flow capacity may be desired, including but not limited to torque motors of any size, may be coupled to thereto. Also, because the servo valve module is made up of at least two plates, a flow capacity of the module may be customized. For example, in configurations in which a larger flow capacity may be desired, a connector plate and/or a cover plate including a valve seat having a larger diameter and a second valve element having a correspondingly larger diameter may be incorporated. In configurations in which a smaller flow capability may be desired, the components may be exchanged for those having smaller diameter valve seats and second valve elements. Additionally, by including a spiral washer and the diaphragm in the servo valve module as mechanisms for transmitting pressure signals from the torque motor module, the servo valve module may be more simply designed and more lightweight than conventional servo valves, while maintaining substantially similar or improved operating capabilities. These mechanisms also allow the servo valve module to have a smaller volume and envelope than conventional servo valves.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A servo valve module comprising:
a housing assembly including a connector plate and a cover plate coupled to the connector plate to define a first chamber, a second chamber, a valve port, an intake port, and an outlet flow channel, wherein the first chamber is in flow communication with the intake port, the valve port provides communication between the first chamber and the second chamber, and the second chamber is disposed between the first chamber, the output port, and the inlet channel;
a diaphragm extending across the second chamber to divide the second chamber into a pressure reception section and a pressure transmission section, wherein the pressure reception section is isolated from the pressure transmission section, and the pressure transmission section is in flow communication with the first chamber and the output port;
a valve assembly disposed within the housing assembly, the valve assembly including:
a valve seat adjacent to the valve port in the first chamber;
a valve element disposed in the first chamber and adapted to seat and unseat against the valve seat, and
a valve plate disposed in the pressure transmission section of the second chamber and including a valve stem extend axially therefrom, the valve stem disposed in the valve port and adapted to contact the valve element; and
a spiral washer coupled to the valve element and extending across at least a portion of the chamber and adapted to provide a preload against the valve element to bias the element toward the closed position.

2. The servo valve module of claim 1, wherein the diaphragm comprises non-reinforced rubber.

3. The servo valve module of claim 1, wherein the spiral washer has an opening, an outer periphery, and a pilot extending radially outwardly therefrom, wherein a portion of the valve element is disposed in the opening of the spiral washer, and the pilot is disposed in a groove in the housing assembly.

4. The servo valve module of claim 3, wherein the groove is formed in the connector plate.

5. The servo valve module of claim 3, wherein the connector plate includes a first section and a second section, and the pilot of the spiral washer is disposed between the first section and the second section.

6. The servo valve module of claim 1, wherein the spiral washer is configured to provide a preload to bias the valve element toward the valve seat.

7. The servo valve module of claim 1, wherein the spiral washer includes a spiral cutout having a topology of an Archimedean spiral.

8. The servo valve module of claim 1, wherein the diaphragm is adapted to flex in response to a pressure in a range of from about 0 psi to about 15 psi exerted thereagainst.

9. The servo valve module of claim 1, wherein the valve element comprises a ball element.

10. A torque motor assembly, comprising:
a torque motor module including:
a torque motor plate including a main flowpath and an output port in flow communication therewith, and
a first valve element disposed between the main flowpath and the outlet port; and
a servo valve module detachably coupled to the torque motor module, the servo valve module including:
a housing assembly including a connector plate and a cover plate, the connector plate coupled to the torque motor plate and defining a first chamber, a second chamber, a valve port, an intake port, an outlet flow channel, and an inlet channel with the cover plate, wherein the first chamber is in flow communication with the intake port, the valve port providing communication between the first chamber and the second chamber, the second chamber is disposed between the first chamber, the output port, and the inlet channel, and the inlet channel is in communication with the output port of the torque motor plate;
a diaphragm extending across the second chamber to divide the second chamber into a pressure reception section and a pressure transmission section, wherein the pressure reception section is in flow communication with the inlet channel and isolated from the pressure transmission section, and the pressure transmission section is in flow communication with the first chamber and the outlet flow channel;
a valve assembly disposed within the housing assembly, the valve assembly including:
a valve seat adjacent to the valve port in the first chamber;
a second valve element disposed in the first chamber and adapted to seat and unseat against the valve seat, and
a valve plate disposed in the pressure transmission section of the second chamber and including a valve stem extend axially therefrom, the valve stem disposed in the valve port and adapted to contact the second valve element; and
a spiral washer coupled to the second valve element and extending across at least a portion of the chamber and adapted to provide a preload against the second valve element to bias the element toward the closed position.

11. The torque motor assembly of claim 10, wherein the torque motor module further comprises a torque motor coupled to the first valve element, wherein the first valve element comprises a flapper.

12. The torque motor assembly of claim 10, further comprising an inlet port in flow communication with the main flowpath of the torque motor module, the inlet port defining a first airflow capacity, and the valve port defining a second airflow capacity that is greater than the first airflow capacity.

13. The torque motor assembly of claim 10, wherein the diaphragm comprises non-reinforced rubber.

14. The torque motor assembly of claim 10, wherein the spiral washer has an opening, an outer periphery, and a pilot extending radially outwardly therefrom, wherein a portion of the valve element is disposed in the opening of the spiral washer, and the pilot is disposed in a groove in the housing assembly.

15. The torque motor assembly of claim 14, wherein the groove is formed in the connector plate.

16. The torque motor assembly of claim 14, wherein the connector plate includes a first section and a second section, and the pilot of the spiral washer is disposed between the first section and the second section.

17. The torque motor assembly of claim 10, wherein the spiral washer is configured to provide a preload to bias the valve element toward the valve seat.

18. The torque motor assembly of claim 10, wherein the spiral washer includes a spiral cutout having a topology of an Archimedean spiral.

19. The torque motor assembly of claim 10, wherein the diaphragm is adapted to flex in response to a pressure in a range of from about 0 psi to about 15 psi exerted thereagainst.

20. The torque motor assembly of claim 10, wherein the valve element comprises a ball element.
